(19) United States
(12) Patent Application Publication
(10) Pub. No.: US 2014/0129265 A1
(43) Pub. Date: May 8, 2014

(54) METHOD AND APPARATUS FOR PROVIDING SERVICES TO PARTNERS AND THIRD PARTY WEB DEVELOPERS

(71) Applicant: Sabre, Inc., Southlake, TX (US)

(72) Inventors: Sean Arena, Fort Worth, TX (US); John Blankenbaker, Dallas, TX (US); Rajeev Bellubbi, Coppell, TX (US); James French, Southlake, TX (US); Rosauro Chito Manansala, Keller, TX (US); Ben Vinod, Grapevine, TX (US)

(73) Assignee: Sabre, Inc., Southlake, TX (US)

(21) Appl. No.: 14/071,286

(22) Filed: Nov. 4, 2013

Related U.S. Application Data
(60) Provisional application No. 61/721,707, filed on Nov. 2, 2012.

(51) Int. Cl. G06Q 30/02; G06Q 50/14

(52) U.S. Cl. CPC G06Q 30/0201; G06Q 50/14
USPC 705/5; 705/7.29; 705/7.31

(57) ABSTRACT

A system, method, apparatus and computer program product are provided in accordance with an example embodiment in order to provide a collection of services in a cloud environment that may be utilized by partners and web developers to build innovative travel applications. An example method may comprise providing a plurality of application user interfaces (APIs) allowing development of an application, each of the plurality of APIs being classified as at least one of an informational service, a transactional service, or an intelligence service, each informational service comprising static content, each transactional service configured for at least one of booking, shopping, or fulfillment transactions, and each intelligence service comprising contextual performance metrics derived from at least one of shopping data or transactional data.

### TECHNOLOGICAL FIELD

A system, method, apparatus and computer program product are provided in accordance with an example embodiment in order to provide a collection of services in a cloud environment that may be utilized by partners and web developers to build innovative travel applications.

### BACKGROUND

Cloud computing is the use of computing resources (hardware and software) that are delivered as a service over a network. Cloud providers manage the infrastructure and platforms on which the applications run. End users access cloud-based applications through a web browser or a light-weight desktop or mobile app while the business software and user's data may be stored on servers at a remote location.

The travel and tourism industry is the largest industry in the world. Tourism is important, and in some cases, vital for many countries. Tourism brings in large amounts of income in payment for goods and services available, accounting for 30% of the world's exports of services, and 6% of overall exports of goods and services. It also creates opportunities for employment in the service sector of the economy.

A need exists to deliver a comprehensive set of services in a cloud environment across multiple lines of business to enable partners and third party developers to develop an application quickly and provide a collection of services and/or Application Program Interfaces (APIs) that partners and third party web developers may utilize to build innovative travel applications.

### BRIEF SUMMARY

To support a large transaction volume in the travel and transportation industry, booking, pricing and ticketing applications have been developed. With the evolving business landscape and new business models that are being introduced, a vast application portfolio and derived content from the volume of business transacted may be utilized to support emerging business partnership opportunities in the online space.

As such, a system, method, apparatus and computer program product are provided in accordance with an example embodiment of the present invention in order to deliver a comprehensive set of services across multiple lines of business to enable partners and third party developers to develop an application quickly and provide a collection of APIs that partners and third party web developers may utilize to build innovative travel applications. For example, in some embodiments, Sabre as a Platform (SaaP), may be a collection of Application Program Interfaces (API's) that allow web developers to build innovative travel applications. Each API may be a relatively low level service and designed for quick response, with, for example, computational intelligence in the background. For example, a website dedicated to golf travel could merge their knowledge of popular golf courses together with the airline and hotel shopping API's, for example, to find opportunities for their visitors.

With new services constantly evolving to meet the future needs of travel across the entire spectrum (e.g., new generation full text search web sites, meta, informational sites, online travel agencies, travel suppliers (airlines, hotels, etc.), tourism boards, journals, research institutions and tomorrow's travel hot spots), an advantage that may be realized by some embodiments discussed herein allows for the strength and uniqueness of deep industry knowledge, leading algorithms to support the travel planning process and the richness of the transaction and shopping data, having been previously collected, stored in a data warehouse.

In some embodiments, a method may be provided comprising providing a plurality of application user interfaces (APIs) allowing development of an application, each of the plurality of APIs being classified as at least one of an informational service, a transactional service, or an intelligence service, each informational service comprising static content, each transactional service configured for at least one of booking, shopping, or fulfillment transactions, and each intelligence service comprising contextual performance metrics derived from at least one of shopping data or transactional data.

In some embodiments a response time associated with a transaction resulting from utilization of a first subset of the plurality of APIs being less than a first predetermined time, and a response time associated with a transaction resulting from utilization of a second subset of the plurality of APIs being less than a second predetermined time. In some embodiments each of the plurality of APIs is a Representational State Transfer (REST) API. In some embodiments, the method may further comprise causing the apparatus to receive a read request identified by a uniform resource locator associated with an API allowing edge-caching to shorten response times.

In some embodiments the providing of the plurality of APIs includes providing a fare forecasting service, the fare forecasting service when executed predicting an increase or decrease in a fare and providing a recommendation of whether to buy. In some embodiments the providing of the plurality of APIs includes providing an air fare range service, the air fare range service when executed calculating an air fare range based on ticked passenger data for at least one of a market and departure date In some embodiments the providing of the plurality of APIs includes providing a plurality of transactional services, at least one transaction service related to an air service and at least one related to a hotel service, and in some embodiments, the method may further comprise causing the apparatus to provide package shopping results.

In some embodiments, a computer program product may be provided comprising a non-transitory computer readable medium having program code portions stored thereon, the program code portions configured, upon execution to provide a plurality of application user interfaces (APIs) allowing development of an application, each of the plurality of APIs being classified as at least one of an informational service, a transactional service, or an intelligence service, each informational service comprising static content, each transactional service configured for at least one of booking, shopping, or fulfillment transactions, and each intelligence service comprising contextual performance metrics derived from at least one of shopping data or transactional data.

In some embodiments a response time associated with a transaction resulting from utilization of a first subset of the plurality of APIs being less than a first predetermined time, and a response time associated with a transaction resulting from utilization of a second subset of the plurality of APIs being less than a second predetermined time. In some embodiments each of the plurality of APIs is a Representational State Transfer (REST) API. In some embodiments, the at least one memory and computer program code are further configured to, with the processor, cause the apparatus to receive a read request identified by a uniform resource locator associated with an API allowing edge-caching to shorten response times.

In some embodiments the providing of the plurality of APIs includes providing a fare forecasting service, the fare forecasting service when executed predicting an increase or decrease in a fare and providing a recommendation of whether to buy. In some embodiments the providing of the plurality of APIs includes providing an air fare range service, the air fare range service when executed calculating an air fare range based on ticked passenger data for at least one of a market and departure date In some embodiments the providing of the plurality of APIs includes providing a plurality of transactional services, at least one transaction service related to an air service and at least one related to a hotel service, and the at least one memory and computer program code are further configured to, with the processor, cause the apparatus to provide package shopping results.

In some embodiments, a computer program product may be provided comprising a non-transitory computer readable medium having program code portions stored thereon, the program code portions configured, upon execution to provide a plurality of application user interfaces (APIs) allowing development of an application, each of the plurality of APIs being classified as at least one of an informational service, a transactional service, or an intelligence service, each informational service comprising static content, each transactional service configured for at least one of booking, shopping, or fulfillment transactions, and each intelligence service comprising contextual performance metrics derived from at least one of shopping data or transactional data.

In some embodiments, a response time associated with a transaction resulting from utilization of a first subset of the plurality of APIs being less than a first predetermined time, and a response time associated with a transaction resulting from utilization of a second subset of the plurality of APIs being less than a second predetermined time. In some embodiments each of the plurality of APIs is a Representational State Transfer (REST) API. In some embodiments, the program code portions are further configured, upon execution, to receive a read request identified by a uniform resource locator associated with an API allowing edge-caching to shorten response times.

In some embodiments, the providing of the plurality of APIs includes providing a fare forecasting service, the fare forecasting service when executed predicting an increase or decrease in a fare and providing a recommendation of whether to buy. In some embodiments, the providing of the plurality of APIs includes providing an air fare range service, the air fare range service when executed calculating an air fare range based on ticked passenger data for at least one of a market and departure date. In some embodiments, the providing of the plurality of APIs includes providing a plurality of transactional services, at least one transaction service related to an air service and at least one related to a hotel service, and the program code portions are further configured, upon execution, to provide package shopping results.

### BRIEF DESCRIPTION OF THE SEVERAL VIEWS OF THE DRAWINGS

Having thus described certain embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is a schematic representation of a cloud computing system that may support communications between a cloud computing environment and a computing device;

FIG. 4 is table showing an exemplary list of services, names of services, and a description of those services in accordance with an example embodiment of the present invention; and

FIG. 5 is a flow chart illustrating the operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

Any reference to “Sabre” herein may include a system, method, apparatus or computer program product provided in accordance with an example embodiment in order to provide a collection of services in a cloud environment that may be utilized by partners and web developers to build innovative travel applications.

### Example Architecture

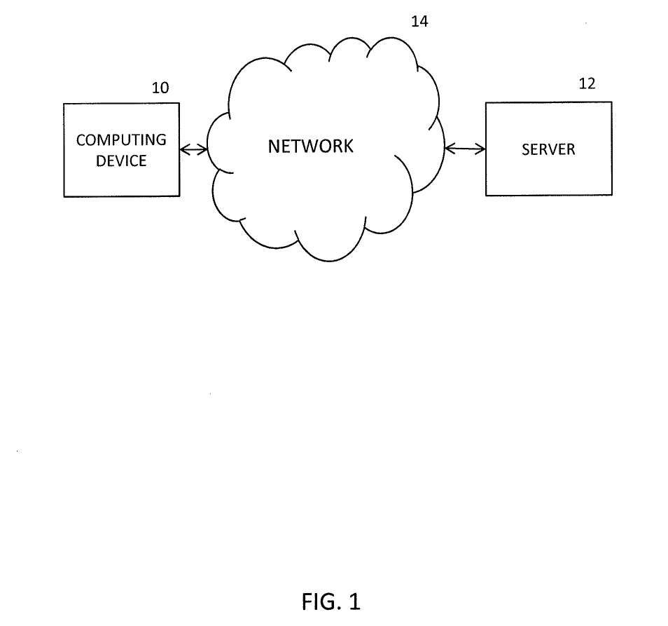

Referring now of FIG. 1, a system that supports communication, either wirelessly or via a wireline, between a computing device 10 and a server 12 or other network entity (hereinafter generically referenced as a “server”) is illustrated. As shown, the computing device and the server may be in communication via a network 14, such as a wide area network, such as a cellular network or the Internet or a local area network. However, the computing device and the server may be in communication in other manners, such as via direct communications between the computing device and the server.

The computing device 10 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

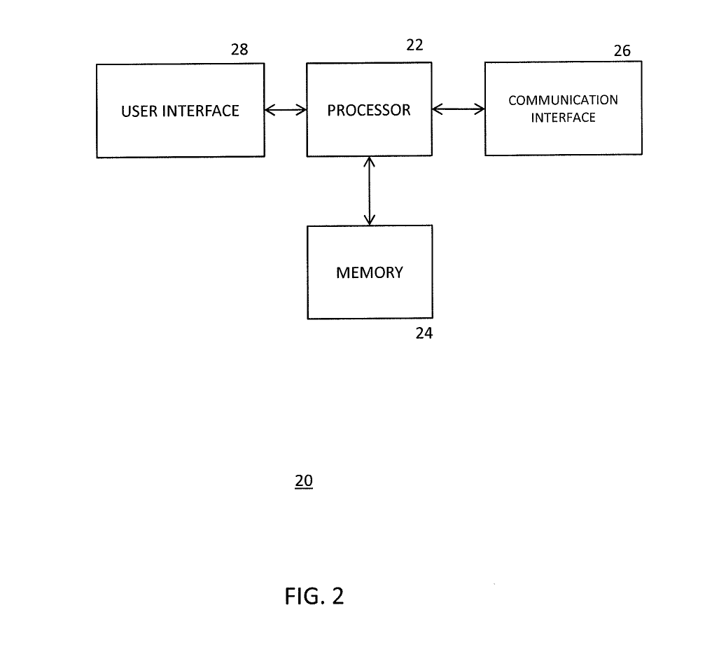

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

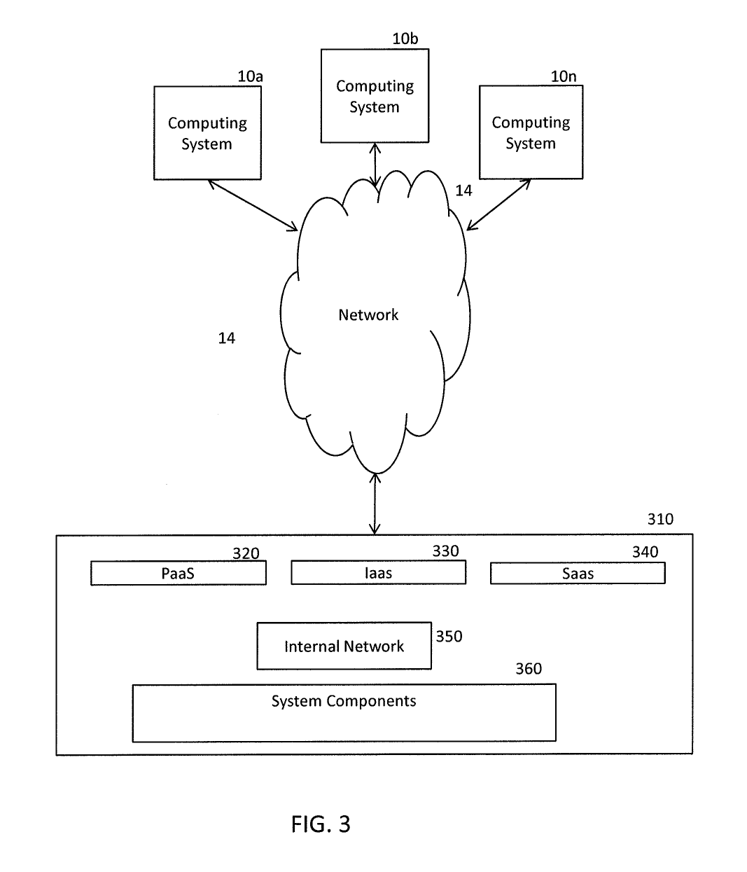

FIG. 3 is block diagram showing one example of a cloud computing system. FIG. 3 shows computing devices 10a, 10b, and 10n that may be coupled to a cloud computing system 310 via a network 14. Network 14 may be the Internet. Network 14 may instead be any other network, e.g., a public/private network or a wireless network. Computing devices 10a, 10b, and 10n depicted in FIG. 3 may be a mobile communication device, such as a cellular phone. Although not shown in FIG. 3, computing devices 10a, 10b, and 10n may be any computing device configured to communicate over a network, for example a desktop computer, a laptop computer, tablet computer, a television, or any other device configured to communicate information via network 14, whether the device's primary purpose is network-based communication or not. Further, computing devices 10a, 10b, and 10n may be coupled to network 14 by any number of known mechanisms for network communications, for example wired connections (e.g., Ethernet) or wireless connections (e.g., Wi-Fi, cellular) to network 14.

As depicted in FIG. 3, computing devices 10a, 10b, and 10n are coupled to a cloud computing system 310 via network 14. In order to access information accessible from could cloud computing system 310, a browser application may run on computing devices 10a, 10b, and 10n. Browser may be configured to run within a local operating system of computing device 10. Non-limiting examples of known browser applications include Microsoft Explorer™, Apple Safari™, Mozilla™, Firefox™ and Google Chrome™ browser. Non-limiting examples of known operating systems for desktop and/or laptop computers may include Microsoft Vista™, Apple Snow Leopard™, or Linux. Examples of known operating systems for mobile devices (e.g., smartphones, netbooks, etc.) include Microsoft Windows Mobile®, Apple Iphone OS®, and Google Android™ mobile technology platform.

Browser may enable a user to manipulate access to information accessible via network 14. For example, browser may provide a user with an ability to enter one or more uniform resource indicators (URIs, e.g., www.google.com) in order to access a web application, such as, for example, a hypertext markup language (HTML) document. A web application, and/or information used by a web application, may be stored on Cloud computing system 310. Browser may be configured to access web applications and/or other information stored on cloud computing system 310 for presentation of visual information to a user of computing device 10, among other uses.

The system 300 includes computing devices 10a, 10b, and 10n connected to a network 14 such as, for example, a Transport Control Protocol/Internet Protocol (TCP/IP) network (e.g., the Internet.) The computing devices 10a, 10b, and 10n are coupled to the cloud computing system 310. Depending on the type of cloud service provided, a computing device 10 may connect to one of three service endpoints, each of which give varying amounts of control relative to the provisioning of resources within the cloud computing system 310. For example, PaaS 320 will typically give an abstract Application Programming Interface (API) that allows developers to declaratively request or command the backend storage, computation, and scaling resources provided by the cloud, without giving exact control to the user. IaaS 330 will typically provide the ability to directly request the provisioning of resources, such as computation units (typically virtual machines), software-defined or software-controlled network elements like routers, switches, domain name servers, etc., file or object storage facilities, authorization services, database services, queue services and endpoints, etc. SaaS 340 will typically only give information and access relative to the application running on the cloud storage system, and the scaling and processing aspects of the cloud computing system will be obscured from the user.

Furthermore, a cloud computing system 310 may have an internal network 350 not visible to the outside that connect to system components 360. System components may include a memory system including system memory and user memory, processor(s), routers, switches, a message passing system, one or more service controllers, a system controller, etc. The internal network 350 may be encrypted or authenticated and in various embodiments, one or more parts of the cloud computing system 310 may be disposed on a single host.

Cloud APIs are application programming interfaces (APIs) used to build applications in the cloud computing market. Cloud APIs allow software to request data and computations from one or more services through a direct or indirect interface. Cloud APIs most commonly expose their features via representational state transfer (REST) and/or Simple Object Access Protocol (SOAP). Vendor specific and cross-platform interfaces are available for specific functions. Cross-platform interfaces have the advantage of allowing applications to access services from multiple providers without rewriting, but may have less functionality or other limitations versus vendor-specific solutions. Cloud APIs may be segmented into infrastructure, service and application clusters. Service APIs provide an interface into a specific capability provided by a service explicitly created to enable that capability. Database, messaging, web portals, mapping, e-commerce and storage are all examples of service APIs. These services may be referred to as platform as a service (PaaS).

Platform as a service (PaaS) is a category of cloud computing services that provide a computing platform and a solution stack as a service. Along with Application as a Service (SaaS) and Infrastructure as a Service (IaaS), it is a service model of cloud computing. In this model, the consumer creates the software using tools and/or libraries from the provider. The consumer also controls software deployment and configuration settings. The provider provides the networks, servers, storage and other services. PaaS offerings may also include facilities for application design, application development, testing and deployment as well as services such as team collaboration, web service integration and marshaling, database integration, security, scalability, storage, persistence, state management, application versioning, application instrumentation and developer community facilitation. These services are generally provisioned as an integrated solution over the web.

### Example Services

In some embodiments, a system, method, apparatus and computer program product may be provided in accordance with an example embodiment in order to provide a collection of services in a cloud environment that may be utilized by partners and web developers to build innovative travel applications. In some embodiments, a system, method, apparatus and computer program product may provide a plurality of application user interfaces (APIs) allowing development of an application, each of the plurality of APIs being classified as at least one of an informational service, a transactional service, or an intelligence service.

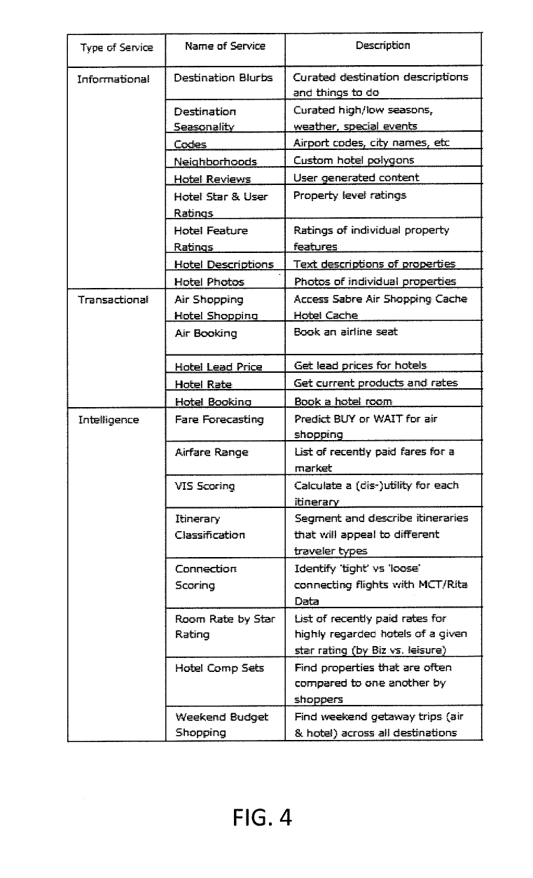

FIG. 4 shows a table showing a summary of RESTful APIs. In one embodiment of the present invention a comprehensive set of services across multiple lines of business (LOB) are delivered to enable partners/third party developers to develop an application quickly. The services may be OTA 2.x/JSON compliant and be REST APIs. In one embodiment, transactions with the exception of booking and ticketing may have a global/worldwide response time of less than 300 ms by deploying the services in a distributed cloud environment with replication. In another embodiment, UC rates for air may be better than competitor UC rates, e.g. Google Flights™ by an order of magnitude. Providing services that introduce key differentiators against competitors that they cannot replicate is achieved by utilizing unique data. For example, decision support services and metrics derived from booking, ticketing and shopping data.

As shown in FIG. 4, the services can be broadly classified as (1) informational service; (2) Transactional services; and (3) Intelligence Services. The services may be consumed by third parties and integrated into their own workflows. In one embodiment, the present invention is achieved by providing the services by deployment of simplified Representational State Transfer (REST) application program interfaces (API's) which provides several advantages for business partners.

The information (state) for read requests is identified by the URL of the service. Hence edge-caching may be used to shorten response times. SOAP requests, which may be used by traditional web services, cannot be cached. Hence, by allowing this information to flow forward and be held close to the users, for example an air shopping cache, overall transaction costs may be driven down and consistently fast response times worldwide may be provided.

A modern web programming approach that uses JavaScript Object Notation (JSON) and OTA 2.x standard as interface definition that is designed for computer use, independent of the green screen messages. This enables an experienced web developer to do something cool in a shortened period of time, such as a day, even if they know little about the complexities of travel retailing.

Time to market is a strategic advantage that Sabre's business partners will benefit from by using the REST API's. Developers can get up to speed rapidly by typing in the sample URLs and then displaying the JSON and/or XML documents in a browser. By using dynamic languages (JavaScript, Python, Ruby, etc) they can connect and get something working the first day. In some embodiments, RESTful API's provides for (optional) code on demand. This allows the system to contain a library of reusable code snippets, such as standard ways to display objects (seat maps, flight routes, etc.). There is also a great deal of interest in RESTful API's in the travel industry and the Open Travel Alliance. As a technology leader in travel and transportation, Sabre supports these new standards.

### Informational Services

In some embodiments, where a system, method, apparatus and computer program product may provide a plurality of application user interfaces (APIs) allowing development of an application, each of the plurality of APIs being classified as at least one of an informational service, a transactional service, or an intelligence service. Informational services may comprise static content.

For example, in some embodiments, informational services may be static content that can be accessed to build an application. Information services may be used for information regarding any aspect of the travel industry. By way of example, informational services may comprise data on destinations, flights and hotels. Destination content may comprise of curated descriptions of destinations, weather and event calendars. Flight content may comprise airport/airline codes, flight timetables/schedules and fare rules. Hotel content may comprise property descriptions, amenities, hotel reviews, star ratings, neighborhood polygons, etc.

### Transactional Services

In some embodiments, where a system, method, apparatus and computer program product may provide a plurality of application user interfaces (APIs) allowing development of an application, each of the plurality of APIs being classified as at least one of an informational service, a transactional service, or an intelligence service, each transactional service configured for at least one of booking, shopping, or fulfillment transactions.

For example, in some embodiments, transactional services may include transactional services related to air and hotels. Transactional services related to air may include air shopping, booking, ticketing, budget shopping, calendar shopping and fare alerts. An Air Shopping Cache may be maintained based on a combination of organic shopping results from OTA's and travel agencies as well as pro-active refresh of the shopping cache based on the algorithm resident in the Cache Controller. The Cache Controller determines when a cache key (origin, destination, departure and return dates by point of sale) needs to be refreshed based on external request arrival rates, organic updates arrival rates and the frequency of fare load transmissions from ATPCO.

Transactional services may further comprise transactional services for Hotels. The transactional services may include hotel shopping, booking and fulfillment. In another embodiment, transactional services may additionally comprise extensions to budget shopping, calendar shopping, and rate alerts.

### Intelligence Services

In some embodiments, where a system, method, apparatus and computer program product may provide a plurality of application user interfaces (APIs) allowing development of an application, each of the plurality of APIs being classified as at least one of an informational service, a transactional service, or an intelligence service, each intelligence service may comprise contextual performance metrics derived from at least one of shopping data or transactional data.

In some embodiments, intelligence Services may reflect, for example, decades of development of advanced analytics and decision support capabilities. In some embodiments, the computation of these metrics may be a function of the underlying shopping and transactional data that are included in the system.

In some embodiments, components of the Intelligence Services may include:

Air Fare Forecasting: An advanced fare prediction model may recommend “when to buy” using a machine learning technique called reinforcement learning. The model predicts when fares will go up or down with, for example a high accuracy, and issuing “BUY” or “WAIT” recommendations as appropriate.

True Hotel Competitive Sets: Using, for example, system click stream data, the conditional probability based on the sequence of properties viewed by the customer may be determined. Using this data, hotel competitor sets for a target property may be determined. In one embodiment, the competitor sets may not be symmetric, e.g., property A may be part of the comp set of property B but the opposite may not be true. True hotel comp sets may have been calibrated from the click stream data associated with the Travelocity hotel path.

Contextual Performance Metrics: Contextual performance metrics may be derived from shopping data and transactional data stored or used by the system.

The Air metrics may include one or more of the following: (1) fare range; (2) Value-based Itinerary Scoring (VIS); (3) Itinerary Classification/Natural Language Generation; (4) Connection Scoring; and (5) Customer Profile based Flight Selection

In some embodiments, the fare range for each market and departure date may be based on recent ticketed passenger data. The fare range may be computed from TDW data weekly.

The VIS score may be based on a calibrated choice model that considers the tradeoffs between price and convenience. The choice model inputs for itinerary scoring include departure time, elapsed time and fare. There are implementation challenges for this service as the response time needs to be relatively quick, but the results depend on particular itineraries returned from the air shopping cache. In one embodiment, these values may be computed as the cache is charged and then stored there.

Itinerary classification may segment and describe itineraries that may appeal to different traveler types and may then, in some embodiments, describe one or more particular trade-offs. Like VIS, implementation of these services may require more than a simple look up since the response depends on the entire set of itineraries.

In some embodiments, a connection sharing service may identify ‘tight’ versus ‘loose’ connecting flights to determine the quality of a connecting itinerary. The model behind the service may be calibrated from minimum connect time (MCT) tables for airports together with monthly DOT on-time performance data (RITA).

In some embodiments, a customer profile based Flight Selection service may be utilized. In one embodiment, a shopping service may be provided that returns a set of flights that have been tailored to a specific customer segment (e.g., itineraries that may appeal to families, itineraries that may appeal to the extremely price conscious consumer, etc.). As an example of such a service, a model may be provided that uses customer zip code as a proxy for wealth to better distinguish between price sensitive and time sensitive customers.

The Hotel and Destination metrics may include one or more of the following: (1) Destination Popularity; (2) Rate Range; (3) Customer Profile based Hotel Selection; and (4)

Destination popularity may be determined based on bookings observed in a first source (e.g., Sabre). In another embodiment, a determination may include bookings from a second source (e.g., Travelocity) in order to counter-balance a bias, such as for example, the known “business trip” bias apparent in Sabre GDS data.

Rate Range may determine the rate ranges by season and star rating based on actual stays from booking data (e.g., Sabre Booking data). In some embodiments, as described above, a blend of data (e.g., data from GDS and Travelocity) may be used to make the determination.

Customer profile based hotel selection may be based on using the self-reported demographic data in reviews (e.g., Travelocity hotel reviews) as filter for hotel displays. For example, customer profile hotel selection may use a filter, hotels that are “good for kids” by looking for top rated hotels in reviews tagged as “traveling with kids”.

In another embodiment, all services with the exception of booking and ticketing may be deployed in a cloud environment to ensure fast predictable response times (e.g., less than 300 ms) globally for all transactions (with the exception of Booking and Ticketing). In steady state, Booking and Ticketing Services may continue to go through a data center and ensure PCI compliance.

Regarding air related services, display may comprise air one or more of (1) shopping results (e.g. air shopping results sourced from Sabre's intelliSell Shopping Cache OR a Live Shopping Call) and search specific parameters. Air shopping results may comprise one or more of a single instance, public fares only in the cache (hence no CAT 25, CAT 35, CAT15 fares), identification of thin markets from TDW (about 500-1,000) and proactively charge the cache, organic cache with proactive polling based on age, response time and price jumps, integrated view with a mapping applications, such as GoogleMaps®, MapQuest®, etc., and/or pricing alerts.

Search specific parameters may comprise a look ahead time period (e.g., 0-192 days and/or inclusive of same day shopping), length of Stay (LOS) (e.g., from 0-14 days and/or inclusive of day trips), simple interlines (e.g., AA out and US return), complex interlines, deep linking capability in GUI (e.g., back to Travelocity), ability to group results by origin point (e.g., a user may specify origin and the map populates many destinations with the lowest fare), shopping by via point and alliance affiliation for business travelers, inbound diversity, calendar shopping, integrated display with a mapping application, (e.g GoogleMaps®).

Furthermore, in some embodiments, a system, method, apparatus, or computer program product provided herein may be configured to further display natural language indicators, fare forecasting, and/or key performance indicators. Natural language generation on the shopping results page may be provided. Fare Forecasting (e.g., predicting when fares would go up/down) may also be provided. A recommendation may be provided such as “Buy Now” and/or “Good Time to Buy”. Key performance indicators (e.g., customer centric) may be provided. For example, key performance indicators may comprise one or more of (i) transaction (bookings and ticketed data) based metrics (e.g., available in TDW), (ii) shopping based metrics (e.g., data sourced from TVL Passport), (iii) query based metrics, or, for example, (iv) public data metrics (e.g., from David Pelter's InsideTrip®) integrated with (i), (ii) and (iii) above.

Regarding hotel related services, display may comprise hotel shopping results. The hotel shopping results may be (1) grouped by hotel type by destination, (2) hotel type, (3) individual hotel rate availability and range by hotel type by destination by check-in date or length of stay, (4) weekday rates versus weekend rates availability, (5) integrated hotel results (e.g., Sabre GDS hotel results) with merchant hotels (e.g., TVLY merchant hotels), (6) integrated display with mapping application (e.g., mapquest) and (7) pricing alerts.

In some embodiments, when a hotel is selected, hotel competitor sets may be displayed. This functionality may be integrated with a mapping application such as GoogleMaps and/or Mapquest. In some embodiments, key performance indicators may be displayed. Key performance indicators (e.g., customer centric, not hotel centric) may include one or more of (i) transactions (bookings) based metrics (e.g., available in TDW and/or Passport (TN+TVLY data)), (ii) hotel shopping based metrics (e.g., data sourced from TVL Passport and TN HOD/HOT data), and (iii) Query based metrics.

In another embodiment, package related services may be provided. Package related services may display package shopping results from any of a plurality of sources (i) based on origin and destination of the request, (ii) provided with quotes by package classification (e.g., discount, good, great) with ranges, such as for example a classification may be created based on the hotel star rating (1, 2 star=Discount; 3, 4 star=Good; 5 star=Great), (iii) assuming packages are primarily sourced from TVLY, (iv) integrated to display with a mapping application (e.g. MapQuest), and/or (v) pricing Alerts.

Package related services may further provide that when a package is selected, hotel competitor sets are displayed. In one embodiment, display of hotel competitor sets may be integrated with GoogleMaps® and/or Mapquest® or any mapping application.

Vacation Planning may be provided as a service. A Vacation Planning (or Trip Planning) service may utilize air, hotel, package services and/or activities optimized for a budget on a schedule. The scope may be limited to a specific geographic area (e.g., Florida, California) or may be not limited. The vacation planning service may provide a booking capability. The vacation planning service may comprise a trip optimizer. For example, the vacation planning service may be configured to optimize air, hotel and activities on a predetermined budget and develop a day by day schedule for the duration of the trip.

In alternative embodiments, trips may be limited to a specific period of time or less. In another embodiment, air services may not be required. In some embodiments, the vacation planning service (or any service disclosed herein) may be configured to generate a documents (hard copy or electronic, such as for example, a PDF) of the trip and allow the user to send the pdf to an email address that may be provided.

In another embodiment, an ability to federate shopping results to third parties is provided. Shopping content may be displayed. A relational database for storing Fare Forecasting rules, KPI's, Hotel Comp Sets, etc. may be provided. In some embodiments, each of the services disclosed herein may be provided for use on any mobile platform.

### Example Method

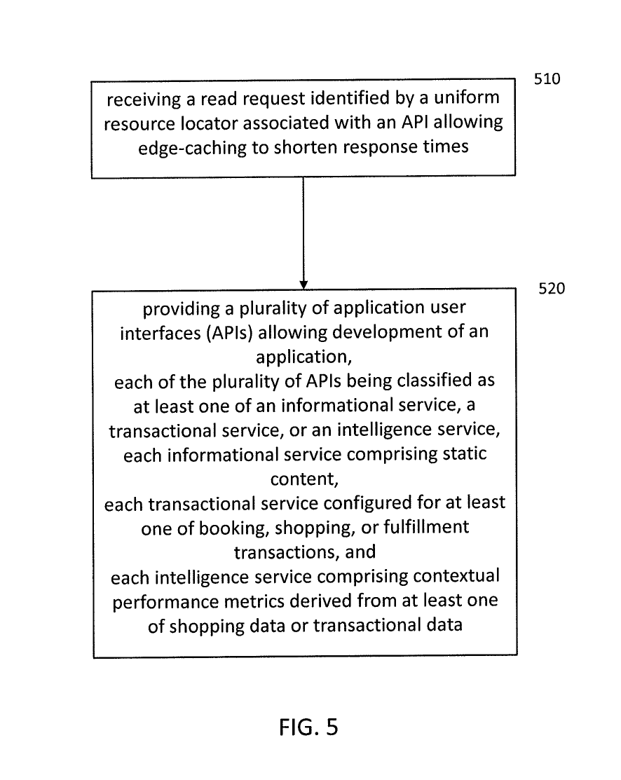

FIG. 5 shows an example method for providing a comprehensive set of services across multiple lines of business to enable partners and third party developers to develop an application quickly and provide a collection of APIs that partners and third party web developers may utilize to build innovative travel applications.

As shown in block 510 of FIG. 4, the apparatus may include means, such as the processor 22 or the like, for receiving a read request identified by a uniform resource locator associated with an API allowing edge-caching to shorten response times.

As shown in block 520 of FIG. 5, the apparatus may include means, such as the processor 22 or the like, for providing a plurality of application user interfaces (APIs) allowing development of an application. In some embodiments, each of the plurality of APIs may be classified as at least one of an informational service, a transactional service, or an intelligence service. In some embodiments, an informational service may comprise static content. The content, for example, may be curated descriptions of destinations, weather, events, or the like. In some embodiments, a transactional service may be configured to provide at least one of a booking, a shopping, or a fulfillment service.

In some embodiments, a transactional service may be configured to provide booking, shopping or fulfillment services related to one or both of air related services or hotel related services. In some embodiments, a transactional service may be configured to provide a package service including, for example, air and hotel related services.

In some embodiments, an intelligence service may be configured to calculate and/or provide contextual performance metrics derived from at least one of shopping data or transactional data. For example, through the providing of the APIs, data related to the use, and, in some embodiments, data related to the shopping and transactions may be stored. By accessing the shopping and/or transactional data, intelligence services may be configured to calculate particular metrics and utilize the metrics to provide useful information. For example, an air fare range service calculate an air fare range based on ticked passenger data for at least one of a market and departure date. In another example, a fare forecasting service may predict an increase or decrease in a fare and provide a recommendation of whether to buy or wait. For example, based on accumulated data, a fare forecasting service may indicate to a user, who may provide a departure date, location, and the like, to buy a fare at a current rate. In other embodiments however, the fare forecasting service may indicate to a user to wait to buy, when for example, prices may decrease in a particular time period.

As described above, embodiments of the present invention may be illustrated by flowcharts of a system, apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
providing a plurality of application user interfaces (APIs) allowing development of an application,
each of the plurality of APIs being classified as at least one of an informational service, a transactional service, or an intelligence service,
each informational service comprising static content,
each transactional service configured for at least one of booking, shopping, or fulfillment transactions, and
each intelligence service comprising contextual performance metrics derived from at least one of shopping data or transactional data.

2. The method of claim 1,
wherein a response time associated with a transaction resulting from utilization of a first subset of the plurality of APIs being less than a first predetermined time, and
wherein a response time associated with a transaction resulting from utilization of a second subset of the plurality of APIs being less than a second predetermined time.

3. The method of claim 1,
wherein each of the plurality of APIs is a Representational State Transfer (REST) API.

4. The method of claim 1, further comprising:
receiving a read request identified by a uniform resource locator associated with an API allowing edge-caching to shorten response times.

5. The method of claim 1, wherein the providing of the plurality of APIs includes providing a fare forecasting service, the fare forecasting service when executed predicting an increase or decrease in a fare and providing a recommendation of whether to buy.

6. The method of claim 1, wherein the providing of the plurality of APIs includes providing an air fare range service, the air fare range service when executed calculating an air fare range based on ticked passenger data for at least one of a market and departure date.

7. The method of claim 1, wherein the providing of the plurality of APIs includes providing a plurality of transactional services, at least one transaction service related to an air service and at least one related to a hotel service; and further comprising providing package shopping results.

8. An apparatus comprising at least one processor and at least one memory including computer program code, the at least one memory and computer program code configured to, with the processor, cause the apparatus to:
provide a plurality of application user interfaces (APIs) allowing development of an application,
each of the plurality of APIs being classified as at least one of an informational service, a transactional service, or an intelligence service,
each informational service comprising static content,
each transactional service configured for at least one of booking, shopping, or fulfillment transactions, and
each intelligence service comprising contextual performance metrics derived from at least one of shopping data or transactional data.

9. The apparatus of claim 8,
wherein a response time associated with a transaction resulting from utilization of a first subset of the plurality of APIs being less than a first predetermined time, and
wherein a response time associated with a transaction resulting from utilization of a second subset of the plurality of APIs being less than a second predetermined time.

10. The apparatus of claim 8,
wherein each of the plurality of APIs is a Representational State Transfer (REST) API.

11. The apparatus of claim 8, the at least one memory and computer program code are further configured to, with the processor, cause the apparatus to:
receive a read request identified by a uniform resource locator associated with an API allowing edge-caching to shorten response times.

12. The apparatus of claim 8, wherein the providing of the plurality of APIs includes providing a fare forecasting service, the fare forecasting service when executed predicting an increase or decrease in a fare and providing a recommendation of whether to buy.

13. The apparatus of claim 8, wherein the providing of the plurality of APIs includes providing an air fare range service, the air fare range service when executed calculating an air fare range based on ticked passenger data for at least one of a market and departure date.

14. The apparatus of claim 8, wherein the providing of the plurality of APIs includes providing a plurality of transactional services, at least one transaction service related to an air service and at least one related to a hotel service; and the at least one memory and computer program code are further configured to, with the processor, cause the apparatus to provide package shopping results.

15. A computer program product comprising a non-transitory computer readable medium having program code portions stored thereon, the program code portions configured, upon execution to:
provide a plurality of application user interfaces (APIs) allowing development of an application,
each of the plurality of APIs being classified as at least one of an informational service, a transactional service, or an intelligence service,
each informational service comprising static content,
each transactional service configured for at least one of booking, shopping, or fulfillment transactions, and
each intelligence service comprising contextual performance metrics derived from at least one of shopping data or transactional data.

16. The computer program product of claim 15,
wherein a response time associated with a transaction resulting from utilization of a first subset of the plurality of APIs being less than a first predetermined time, and
wherein a response time associated with a transaction resulting from utilization of a second subset of the plurality of APIs being less than a second predetermined time.

17. The computer program product of claim 15,
wherein each of the plurality of APIs is a Representational State Transfer (REST) API.

18. The computer program product of claim 15, the program code portions are further configured, upon execution, to:
receive a read request identified by a uniform resource locator associated with an API allowing edge-caching to shorten response times.

19. The computer program product of claim 15, wherein the providing of the plurality of APIs includes providing a fare forecasting service, the fare forecasting service when executed predicting an increase or decrease in a fare and providing a recommendation of whether to buy.

20. The computer program product of claim 15, wherein the providing of the plurality of APIs includes providing an air fare range service, the air fare range service when executed calculating an air fare range based on ticked passenger data for at least one of a market and departure date.

21. The computer program product of claim 15, wherein the providing of the plurality of APIs includes providing a plurality of transactional services, at least one transaction service related to an air service and at least one related to a hotel service; and the program code portions are further configured, upon execution, to provide package shopping results.
